(19) United States
(12) Patent Application Publication
(10) Pub. No.: US 2016/0060493 A1
(43) Pub. Date: Mar. 3, 2016

(54) SYNTHETIC-RESIN ADHESIVE COMPOSITIONS COMPRISING BIOGENIC REACTIVE DILUENTS AND RESINS

(71) Applicant: FISCHERWERKE GMBH & CO. KG, Waldachtal (DE)

(72) Inventors: Jürgen GRÜN, Botzingen (DE); Martin VOGEL, Glottertal (DE); Christian SCHLENK, Denzlingen (DE); Christian WEINELT, Emmendingen (DE)

(73) Assignee: Fischerwerke GMBH & Co. KG, Waldachtal (DE)

(21) Appl. No.: 14/779,855

(22) PCT Filed: Mar. 21, 2014
(86) PCT No.: PCT/EP2014/000774

§ 371 Date: Sep. 24, 2015

(30) Foreign Application Priority Data
Apr. 5, 2013 (DE) 10 2013 103 399.7

(51) Int. Cl. C09J 133/14; C08K 3/34

(52) U.S. Cl. CPC C09J 133/14; C08K 3/34; C09J 2433/003

(57) ABSTRACT

Multi-component synthetic resin adhesive composition for the fixing sector, especially for adhesively bonding an anchoring element in a hole or crevice, comprising reactive diluents and/or resins and optionally further additives, characterised in that the reactive diluent and/or the resin comprise(s) at least one reactive diluent and/or resin having biogenic content, and the use thereof in the fixing sector, and related aspects.

### TECHNICAL FIELD OF THE INVENTION

The invention relates to multi-component synthetic resin adhesive compositions for the fixing sector, especially for adhesively bonding an anchoring element in a hole (for example, a drilled hole) or crevice, comprising reactive diluents, resins and optionally further additives, and to further subject-matter of the invention mentioned hereinbelow.

### DISCUSSION OF RELATED ART

A multiplicity of (for example, injectable) fixing mortar systems (synthetic resin adhesive compositions) based on an extremely wide variety of polymer-forming components is known, sometimes in the form of single-component systems and sometimes in the form of two-component or multi-component systems, which are used for embedding anchoring means, such as bolts, anchor rods or the like, in mortar in holes, such as drilled holes, or crevices, in each case in solid substrates such as, for example, masonry or concrete. Further components, for example facing elements, can then be fixed to the anchoring means. The embedding of the anchoring means in mortar is based, on the one hand, on adhesive effects in the sense of a material-bonded connection between the synthetic resin and an anchoring element and/or the wetted surface of the hole or crevice and/or, on the other hand, on an interlocking connection, such as, for example, undercuts formed by using the synthetic mortar to surround projecting or recessed portions of the anchoring element and/or of a hole or crevice.

Documents such as WO 2010130919A1 (glue-like compositions for wood products, for example with biogenic polyols), WO 2009087360 A1 (binders for chipboards and the like, for example with glycerol from biodiesel production as additive to silicate solutions); WO 2011019997 A1, WO 2011020010 A1, and WO 2011020004 A1 (polyols such as castor oil or glycerol as reaction components in urethane production for shaped bodies with isocyanates); WO 2008/014549 A1 (inter alia polyols as constituents of phenol resins), or WO 2007112104 A1 (polyols as reaction partners for isocyanates for forming polyurethane moulded bodies) describe additives that are partly of vegetable origin.

Other documents from the prior art, for example EP 1 118 628 A1 or WO 2003044114 A1, relate to mortar compositions as, in the first case, two-component epoxy-based products as, in the second case, adhesives for securing nuts to screws based on free-radical-hardenable resins which comprise glycerol triglycidyl ethers or alkanediol(meth)acrylates and glycerol(methacrylates) as components, but they are not characterised as biogenic.

The prior art accordingly relates to problems and solutions that differ from the present invention.

In the synthetic resins and plastics sector there is, for ecological and economic reasons and as a result of legislation making it favourable, a requirement to reduce the organically bound carbon content of fossil constituents (obtained, for example, from petroleum, lignite coal or bituminous coal).

Biomass and/or biosphere-based (renewable, sustainable, bio-based) or just “biogenic” raw materials for carbon are sparing of resources and, because of their long-term obtainability, are of special interest.

In order to assess the proportion of bio-based raw materials it is customary to ascertain the proportion of bio-based carbon, which is detected by means of the ¹⁴C method. Because the ratio of carbon isotopes can still be determined after the production process, it is possible to distinguish between fossil and biogenic biomass.

Bio-based products can consist entirely or at least partly of bio-based raw materials. It is also possible for further additional substances, inorganic substances or fossil materials, or two or more thereof, to be included.

Efforts are being made to make standardised certifications for products with bio-based contents possible. An example is the certification program for bio-based products according to ASTM 6866 by TÜV Rheinland (DIN CERTCO, Berlin, Germany) in order to gain the right to mark a product with the certification “Bio-based . . . %, DIN-tested”, for example “Bio-based 50 to 85%, DIN-tested”.

In order to gain such certification, a double minimum requirement is imposed: firstly, the minimum content of organic material, determinable as loss on ignition, must be at least 50% by weight.

Secondly, the content of bio-based carbon must exceed 20% by weight (for a certification of “Bio-based 20 to 50%, DIN-tested”, it must be between 20 and 50% by weight; for a certification of “Bio-based 50 to 85%, DIN-tested”, it must be between 50 and 85% by weight; for a certification of “Bio-based >85%, DIN-tested”, it must be at least 85% by weight).

Testing of a product is carried out by taking samples from production or from marketing/selling channels (usually by the manufacturer or the seller themselves) and testing them. An initial test is carried out, and regular monitoring.

In this, the loss on ignition can be determined by customary methods. It corresponds to the amount of organic material. A known mass m₀ of test material is ashed, and the mass of the solid residue obtained m_{f} is determined and subtracted from m₀. This corresponds to the volatile and/or organic content of the test material. A high loss on ignition indicates a high organic substance content in the sample, because the carbon contained therein is oxidised and is given off in the form of carbon dioxide. The determination can be carried out, for example, in accordance with DIN EN 14775 or DIN 18128.

The bio-based carbon content is carried out on the basis of ASTM 6866 (Standard Test Method for Determining the Biobased Content of Solid, Liquid and Gaseous Samples Using Radiocarbon Analysis (ASTM International, D6866-12: 2008, Method A).

### SUMMARY OF THE INVENTION

A problem of the invention was to increase the proportion of biogenic materials in synthetic resin adhesive compositions and in that way improve environmental and sustainability-related product indicators (as determined, for example, in a life cycle inventory analysis in the context of an Environmental Product Declaration (EPD) or “Carbon Footprint”). The consumption of energy should be reduced and the carbon dioxide balance improved.

A further objective is for the fixing systems to have a bio-based C content of >20, especially >50, >55, >60, >65, >70, >75 or >80% (tested in accordance with ASTM 6866) (accordingly, preferred variants of the invention are characterised by such contents).

It has now been found that (where mentioned, in each case) biogenic reactive diluents and resins are excellently suitable for realising synthetic resin adhesive compositions of the kind mentioned at the outset.

The invention accordingly relates, in a first embodiment, to a multi-component synthetic resin adhesive composition as mentioned at the outset, characterised in that it comprises as reactive diluent and/or as resin at least one reactive diluent and/or reactive resin that is biogenic or has a biogenic content, preferably at least one such reactive diluent and/or resin that is biogenic or has a biogenic content.

Corresponding processes and methods for embedding anchoring elements in mortar and holes or crevices, wherein a multi-component synthetic resin adhesive composition according to the invention is used for the embedding of anchoring means in mortar, wherein the synthetic resin adhesive composition and an anchoring means are successively, especially first the synthetic resin adhesive composition and then the anchoring means, or (at least substantially) simultaneously introduced into a hole or crevice in a substrate (also in a cracked substrate, such as in cracked concrete), also form embodiments of the invention.

The invention also relates, in a further embodiment, to use of a mentioned reactive biogenic diluent and/or biogenic resin, or in each case mixtures of two or more thereof, as reactive diluent and/or resin for multi-component synthetic resin adhesive compositions, especially for the purposes according to the invention, wherein preferably the corresponding reactive diluent is added to a composition of such a kind.

The definitions hereinbelow serve to clarify certain terms or symbols and to describe special embodiments of the invention; in the embodiments of the invention mentioned hereinabove and hereinbelow it is possible for individual, some or all terms or symbols to be replaced by more specific definitions, resulting in special embodiments of the invention.

Biogenic means preferably that the reactive diluents or resins or (“having biogenic content”) at least parts of their molecules, and optionally other biogenic components, are obtained from plants or vegetable materials or furthermore from animal materials. It is very preferable that the biogenic character can be detected with reference to ASTM 6866 (by way of the C¹⁴ content), as described above.

Where weights are given in percent (% by weight), these relate, if not otherwise stated, to the total mass of the reactants and additives of the synthetic resin adhesive composition according to the invention (that is to say to the constituents and/or their precursors present in the composition to be cured after mixing, without packaging, except in the case of capsules or films which can also act as fillers and make a contribution to the total mass of the hardening or hardened material, and without other possible parts such as static mixers, cartridge housings or the like).

Where reference is made to biogenic resins or those having biogenic content, they are preferably to be understood as including reactive natural or, especially, synthetic resins of such a kind.

Where mention is made of (meth)acrylates, this means acrylates, methacrylates or mixtures thereof.

Reactive diluents or resins having biogenic content are preferably those having one or, preferably, more reactive groups (groups allowing (co)polymerisation, that is to say especially unsaturated or epoxy groups), that is to say especially all at least partly (=in at least one part of the molecule) biogenic starting materials (raw materials) which are functionalised by (preferably biogenic) epichlorohydrin or (meth)acrylic acid, for example by means of OH— or furthermore SH— or amino (NH₂—) or imino (—NH—) groups contained in the (preferably likewise biogenic) complementary (that is to say reacting with the epichlorohydrin or (meth)acrylic acid to form the end product) starting materials (raw materials), or two or more of those groups (or the reactive diluents and resins obtainable by reaction of those starting materials), especially those which contain hydroxyl groups and thus are functionalised to form (correspondingly entirely or at least partly biogenic) (meth)acrylic acid esters or glycidyl ethers, or furthermore those having a correspondingly functionalised amino or carboxyl (COOH) group, such as, for example, (meth)acrylates (preferably having a biogenic (meth)acrylate portion) of hydroxy-group-containing vegetable oils, such as of castor oil or soybean oil, entirely or at least partly biogenic (for example C₁-C₁₀)alkane(mono-, di-, tri-, tetra-, penta- or hexa- or poly-)ol (meth)acrylates, partly or preferably entirely biogenic polyglycerol(meth)acrylates, entirely or partly biogenic (meth)acrylates of sugar alcohols, such as mannitol, xylitol or sorbitol, entirely or partly biogenic (meth)acrylated fusel oils, entirely or partly biogenic 5- or 6-membered ring heterocyclyl(meth)acrylates (especially having one or two hetero atoms selected from O, N and S in the ring), partly or preferably entirely biogenic glycerol- or polyglycerol-(meth)acrylates, entirely or partly biogenic saccharide methacrylates, or UP resins with biogenic or non-biogenic polycarboxyl compounds and biogenic or non-biogenic di- or poly-ols or mixed-functional compounds such as, for example, biogenic lactic acid, wherein at least one of the carboxyl and di- or poly-ol radicals is biogenic; or partly or entirely biogenic C₂-C₁₂ alkyl((mono-, di-, tri-, tetra-, penta-, hexa- or poly-)ol (mono-, di-, tri-, tetra-, penta-, hexa- or poly-)glycidyl ethers), such as trimethylolpropane triglycidyl ether or glycerol triglycidyl ether.

Preferably (especially in the case of products according to the invention) the reactive diluent having biogenic content is not epoxidised castor oil.

Special preference is given to epoxidised soybean oil (meth)acrylate, 1,10-decanediol di(meth)acrylate, tetrahydrofuryl methacrylate, isobornyl(meth)acrylate, sorbitol(meth)acrylate, (meth)acrylated fusel oil, or purely biogenic glycerol tri(meth)acrylate or one in which at least the (meth)acrylate portion is biogenic, or in the case of epoxides entirely or partly (especially in the glycidyl portion) biogenic alkane(mono-, di-, tri-, tetra-, penta-, hexa- or poly-)ol (mono-, di-, tri-, tetra-, penta-, hexa- or poly-)glycidyl ethers, such as trimethylolpropane triglycidyl ether, or partly or preferably entirely biogenic glycerol triglycidyl ether, partly biogenic epoxy resin based on phenols, such as novolak, bisphenol F or bisphenol A or suitable (suitable for the unsaturated or epoxy-based system in question) mixtures of two or more such at least partly biogenic reactive diluents or at least partly biogenic reactive resins are possible. As the person skilled in the art knows, technically often only partly functionalised species are obtained (that is to say, for example, those which have, for example, 3 hydroxy groups per molecule and accordingly can in theory be tri-functionalised, but in practice are functionalised only to a lesser degree, for example on average 2.7-fold), which are also to be covered herein in each case without further reference.

In special cases the (meth)acrylic acid or epichlorohydrin portion is also of biogenic origin. In particular epichlorohydrin (Bruce M. Bell et al: Glycerin as a Renewable Feedstock for Epichlorohydrin Production. The GTE Process. Clean 36 (8), 2008; pages 657-661) and (meth)acrylic acid (for example in accordance with EP 1 710 227 B1, DE 10 2008 038 273 A1 or “Einführung in die Technische Chemie” [Introduction to Technical Chemistry], Arno Behr, David W. Agar, Jakob Jorissen, Spektrum Akademischer Verlag Heidelberg, 2010, page 139) can be produced in accordance with methods known per se from glycerol and lactic acid, respectively.

The reactive diluents having biogenic content are added, for example, in a proportion of from 0.5 to 80% by weight, for example from 1 to 55% by weight. One example of suitable proportions is in the range from 1 to 35% by weight; another example is in the range from 36 to 60% by weight.

“Comprise” or “include” means that other components or features may be present in addition to the components or features mentioned and therefore does not refer to an exhaustive list, unlike “contain”, the use of which does signify an exhaustive list of components or features.

Where the attribute “furthermore” is mentioned, this means that features without this attribute can be more preferred.

“And/or” means that the mentioned features/substances can in each case be present on their own or in a combination of two or more of the individually mentioned features/substances.

“A” usually denotes the indefinite article (except when it is recognisable as a number as immediately afterwards in this sentence) and especially means “at least one” (in the sense of 1, 2 or more).

As the synthetic resin there are used primarily reactive synthetic resins based on epoxy or free-radical-hardenable (=hardening after addition of a free-radical-former (hardener)) reactive synthetic resins (hardenable component), which in each case can be hardened by appropriate hardeners (hardener components), as described, for example, hereinbelow.

Synthetic Resins Based on Epoxy:

The reactive synthetic resins based on epoxy that can be utilised in use of and/or in multi-component synthetic resin adhesive compositions according to the invention comprise an epoxy component, preferably based on glycidyl compounds, for example those having an average glycidyl group functionality of 1.5 or more, especially of 2 or more, for example from 2 to 10, which can optionally comprise further glycidyl ether(s) as reactive diluent. The epoxides of the epoxy component are preferably poly(including di)-glycidyl ethers of at least one polyhydric alcohol or phenol, such as novolak, bisphenol F or bisphenol A, or mixtures of such epoxides, for example obtainable by reaction of the corresponding polyhydric alcohols with epichlorohydrin. Examples are trimethylolpropane triglycidyl ether, novolak epoxy resins, bisphenol A epichlorohydrin resins and/or bisphenol F epichlorohydrin resins, for example having an average molecular weight of ≦2000 Da. The epoxy resins can have, for example, an epoxy equivalent of from 120 to 2000, preferably from 150 to 400, such as especially from 155 to 195, for example from 165 to 185. In a variant according to the invention, resins that have been produced at least partly from biogenic constituents are preferred, because they increase the proportion of biogenic carbon, such as, for example, bisphenol-A-, bisphenol-F- or bisphenol-NF-resins having a biogenic glycidyl portion (obtainable, for example, from Spolchemie, Revolu\check{c}ni 1930/86, 400 32 Ústi nad Labem, Czech Republic). The proportion in the total mass of the reactants and additives of the injectable synthetic mortar system is preferably from 5 to below 100% by weight, especially from 10 to 80% by weight, from 10 to 70% by weight or from 10 to 60% by weight. Also possible are mixtures of two or more such epoxy components. Suitable epoxy resins, reactive diluents and hardeners are also to be found in the reference work by Lee H and Neville K, “Handbook of Epoxy Resins” (New York: McGraw-Hill), 1982 (these compounds are incorporated herein by reference).

“Based on epoxy” means especially that the synthetic resin adhesive compositions according to the invention can also comprise, in addition to the components mentioned hitherto, further customary ingredients (for example, additives or other constituents mentioned hereinabove or hereinbelow). These further ingredients can be present, for example, in an amount of, in total, up to 80% by weight, preferably between 0.01 and 65% by weight. Even when “based on” is not explicitly mentioned, such customary ingredients are also included.

Important examples of further ingredients are one or more selected from accelerators, non-reactive diluents or further (besides the biogenic) reactive diluents, thixotropic agents, fillers and further additives.

As accelerators there may be included, for example, tert-amines, such as imidazoles or tert-aminophenols, such as 2,4,6-trimethylaminomethylphenol, organophosphines or Lewis bases or Lewis acids, such as phosphoric acid esters, or mixtures of two or more thereof, in one or (especially in the case of multi-component systems) more of the components, preferably in each case in a hardener component, for example in a proportion by weight of from 0.001 to 15% by weight, based on the total mass of the reactants and additives of the injectable synthetic mortar system.

As thixotropic agents there can be used customary rheology aids, such as pyrogenic silica (especially, for example, surface-treated to be made hydrophobic) or hydrogenated (solid at room temperature) or hydroxyalkylated castor oils. They can be added, for example, in a proportion by weight of from 0.001 to 50% by weight, for example from 0.5 to 20% by weight.

The fillers can be present in one or more components, for example of a multi-component kit according to the invention, for example in one or both components of a corresponding two-component kit; the proportion of further fillers is preferably from 0 to 90% by weight, for example from 10 to 90% by weight. Biogenic fillers, such as lignin sulfonates, kernel flours or shell flours from fruits, for example coconut shell flour, walnut shell flour or olive stone flour, or vegetable charcoal, or mixtures of two or more thereof, can be used for this purpose. Non-biogenic fillers, such as corundum, quartz sand or quartz powder, can also be added. Furthermore, hydraulically hardenable fillers, such as gypsum, burnt lime or cement (for example, alumina cement or Portland cement), water glasses or active aluminium hydroxides, or two or more thereof, can be added.

Further ingredients can also be added, such as plasticisers, non-reactive diluting agents, flexibilisers, stabilisers, rheology aids, wetting and dispersing agents, colouring additives, such as dyes or especially pigments, for example for staining the components different colours for better monitoring of their intermixing, or the like, mixtures of two or more thereof. Such further additives can preferably be added in total in proportions by weight of in total from 0 to 90%, for example from 0 to 40% by weight.

Some of the compounds mentioned in the definition of epoxides, such as trimethylolpropane triglycidyl ether or hexanediol diglycidyl ether or glycidyloxypropyl-trimethoxysilane, which have a lower viscosity than epoxides comprising aromatic groups, can also be used as further reactive diluents, for example in a proportion by weight of from 0.1 to 90% by weight, for example between 0.5 and 75% by weight or between 1 and 40% by weight.

The hardener comprises at least one compound customary for epoxy hardening (reaction partner in polyaddition), the term “hardener” meaning preferably at least one compound which is customary for epoxy hardening with or without addition of fillers (especially biogenic fillers according to the invention) and/or further additives, such as water, thickeners and/or further additional substances, such as dyes and the like, in other words the complete hardener component. The hardener can be in the form of a separate component and/or also be incorporated (especially in protected form, that is to say, for example, in micro-encapsulated form) in the reactive resin formulation (in the form of a hardenable component, that is to say one which, after mixing with the hardener after breaking-open of the casing of the microcapsule, cures by means of polymerisation). Customary additives can be added, such as, for example, fillers (especially as defined hereinabove) and/or solvents (non-reactive diluents) (especially for producing a paste or emulsion), such as benzyl alcohol and/or water.

The compounds customary for epoxy hardening (which function as reaction partners in the course of polyaddition) are especially those having two or more groups selected from amino, imino and mercapto, for example corresponding amines (preferred), thiols or aminothiols, or mixtures of two or more thereof, for example as mentioned in Lee H and Neville K, “Handbook of Epoxy Resins” (New York: McGraw-Hill), 1982, which is incorporated herein by reference in this regard, for example di- or poly-amines mentioned therein, and/or di- or poly-thiols.

In special embodiments of the invention, the compounds customary for epoxy hardening, the epoxy base or both have no rubber modification.

The compounds customary (generally) for epoxy hardening include, for example in an embodiment of the invention
di- or poly-amines such as especially aliphatic (such as ethylenediamine), cyclo-aliphatic and aromatic di- or poly-amines, amidoamines, amine adducts, polyether diamines or polyphenyl/polymethylenepolyamines, Mannich bases, polyamides and the like (special mention being made of Mannich bases, especially as disclosed in the publication WO 2005/090433, especially on page 3, final paragraph, to page 6, second paragraph, as in Example 1 or, especially, 2 thereof, which is incorporated herein by reference in this regard, or very especially based on (biogenic) cardanol, on their own or in admixture with one or more further di- or poly-amines);
di- or poly-thiols such as especially di-functional or higher functional thiols, for example dimercapto-α,ω-C1-C12alkanes, 4,4′-dimercaptodicyclohexylmethane, di-mercaptodiphenylmethane or the like;
furthermore aliphatic aminols, such as especially hydroxy-lower alkylamines, such as ethanolamine, diethanolamine or 3-aminopropanol, or aromatic aminols, such as 2-, 3- or 4-aminophenol.

Mixtures of two or more of the mentioned compounds customary for epoxy hardening can also be used and/or included.

The compounds customary for epoxy hardening, where present, are present preferably in amounts of up to 95% by weight, preferably from 2 to 70% by weight, based on the total mass of reactants and additives in the mass of the synthetic resin adhesive composition to be cured (for example, the injectable synthetic resin system).

Based on the hardener component of a multi-component synthetic resin adhesive composition according to the invention, the proportion of the corresponding compounds in a possible preferred embodiment of the invention is from 1 to 100% by weight, for example 4 to 95% by weight, 5 to 90% by weight or 10 to 80% by weight.

Especially in the case of a hardener component of a multi-component system according to the invention, further additives can also be constituents of the “hardener”, such as water, organic solvents, such as benzyl alcohol, fillers (for example as mentioned hereinabove) and further ingredients from the ingredients mentioned hereinabove, for example in a proportion by weight of, in total, from 0.01 to 70% by weight, for example from 1 to 40% by weight.

Free-Radical-Hardenable Reactive Synthetic Resins

The free-radical-hardenable reactive synthetic resins (preferred in embodiments of the invention) are primarily those based on free-radical-hardening unsaturated reactive resins and, present in a separate component, free-radical hardeners.

Preferably, no input of heat and/or (for example, UV) light from the outside is necessary for their use.

Free-radical-hardening unsaturated reactive resins are to be understood as being primarily those which comprise, as free-radical-curing (which includes “curable (for example prior to addition of hardener)”) components, organic compounds having unsaturated (for example olefinic) radicals or, especially, which consist of such compounds, especially those which comprise 2 or more unsaturated (olefinic) radicals per molecule, primarily those which include hardenable esters with unsaturated carboxylic acid radicals; preferably in each case propoxylated or, especially, ethoxylated aromatic diol-, such as bisphenol-A-, bisphenol-F- or novolak-(especially di-)(meth)acrylate, epoxy(meth)acrylates, especially in the form especially of reaction products of di- or poly-epoxides, for example bisphenol-A-, bisphenol-F- or novolak-di- and/or -poly-glycidyl ethers, with unsaturated carboxylic acids, for example C₂-C₇alkenecarboxylic acids, such as especially (meth)acrylic acid, urethane- and/or urea-(meth)acrylates (which also includes oligomeric or polymeric variants), and/or unsaturated polyester resins, or the like; for example having an average molecular weight of ≦2000; or two or more of such hardenable unsaturated organic components; for example they are present in a proportion by weight of from 0.1 to 90% by weight, for example between 0.5 and 75% by weight or between 1 and 40% by weight or from 40 to 65% by weight.

Examples of epoxy(meth)acrylates present in and/or used in special embodiments of the invention are those of formula

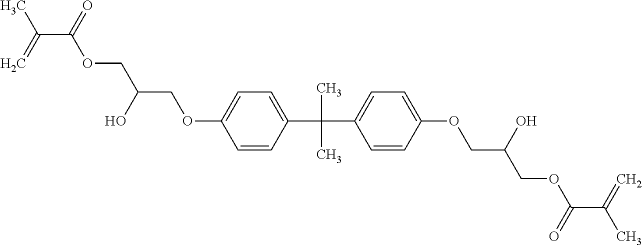 [SMILES: C=C(C)C(=O)OCC(O)COc1ccc(C(C)(C)c2ccc(OCC(O)COC(=O)C(=C)C)cc2)cc1]

or, more generally, taking into account the prelengthening reaction in the preparation of the bisphenol A diglycidyl ether of formula

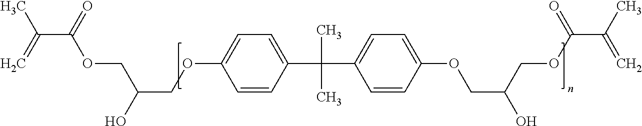

wherein n denotes a number greater than or equal to 1 (when mixtures of different molecules having different n values are present and are represented by the formula, non-integer numbers are also possible as a mean value). These too are subsumed hereinbelow under the term “vinyl esters”.

Examples of propoxylated or, especially, ethoxylated aromatic diol-, such as bisphenol-A-, bisphenol-F- or novolak-(especially di-)(meth)acrylates present in and/or used in special embodiments of the invention are those of formula

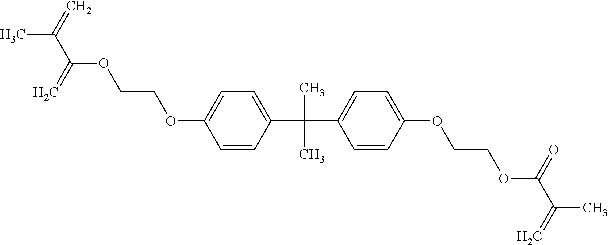 [SMILES: C=C(C)C(=C)OCCOc1ccc(C(C)(C)c2ccc(OCCOC(=O)C(=C)C)cc2)cc1]

or, generally, also taking into account higher degrees of ethoxylation:

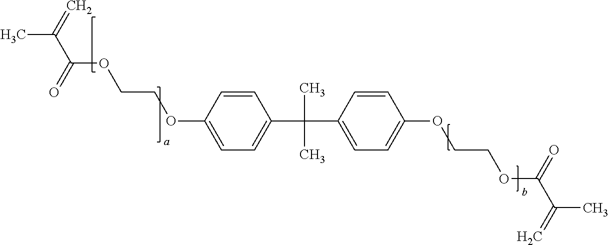

wherein a and b each independently of the other denote a number greater than or equal to 0, with the proviso that preferably at least one of the values is greater than 0, preferably both values being 1 or more (when mixtures of different molecules having different (a and b) values are present and are represented by the formula, non-integer numbers are also possible as a mean value, but for individual molecules seen in isolation only integers in each case). These too are subsumed hereinbelow under the term “vinyl esters”.

Important examples of further ingredients here are aminic accelerators, inhibitors, non-reactive diluents or further (besides the biogenic) reactive diluents, thixotropic agents, fillers and/or further additives.

As aminic accelerators there come into consideration those having sufficiently great activity, such as especially (preferably tertiary, especially hydroxyalkylamino-group-substituted) aromatic amines selected from the group selected from epoxyalkylated anilines, toluidines or xylidines, such as, for example, ethoxylated toluidine, aniline or xylidine, for example N,N-bis(hydroxypropyl or hydroxyethyl)-toluidines or -xylidines, such as N,N-bis(hydroxypropyl or hydroxyethyl)-p-toluidine, N,N-bis(hydroxyethyl)-xylidine and more especially corresponding higher alkoxylated technical products. One or more such accelerators are possible. The accelerators preferably have a content (concentration) of from 0.005 to 10%, especially from 0.1 to 5% by weight.

As inhibitors there can be added, for example, non-phenolic (anaerobic) and/or phenolic inhibitors.

As phenolic inhibitors (which are often provided as a component already mixed in with commercial free-radical-hardening reactive resins but which, furthermore, may also be absent) there come into consideration (non-alkylated or alkylated) hydroquinones, such as hydroquinone, mono-, di- or tri-methyl hydroquinone, (non-alkylated or alkylated) phenols, such as 4,4′-methylene-bis(2,6-di-tert-butylphenol), 1,3,5-trimethyl-2,4,6-tris(3,5-di-tert-butyl-4-hydroxybenzyl)-benzene, (non-alkylated or alkylated) pyro-catechols such as tert-butyl-pyrocatechol, 3,5-di-tert-butyl-1,2-benzenediol, or especially 4-methoxyphenol, or mixtures of two or more thereof. These have preferably a content of up to 1% by weight, especially between 0.0001 and 0.5% by weight, for example between 0.01 and 0.1% by weight.

As non-phenolic or anaerobic (that is to say, unlike the phenolic inhibitors, active also without oxygen) inhibitors (which especially have scarcely any effect on the curing times) there come into consideration preferably phenothiazine or organic nitroxyl free radicals. As organic nitroxyl free radicals there can be added, for example, those described in DE 199 56 509, which are incorporated herein by reference especially in respect of the compounds mentioned therein, especially 1-oxyl-2,2,6,6-tetramethyl-piperidin-4-ol (“4-OH-TEMPO” or “TEMPOL”). The proportion by weight of the non-phenolic inhibitors is preferably in the range of from 1 ppm (by weight) to 2% by weight, especially, for example, in the range of from 10 ppm to 1% by weight, based on the reactive resin formulation.

As thixotropic agents there can be used customary thixotropy-imparting rheology aids, such as pyrogenic silica and/or hydrogenated (solid at room temperature) or hydroxyalkylated castor oils. They can be added, for example, in a proportion by weight of from 0.01 to 50% by weight, for example from 0.5 to 20% by weight.

As fillers there can be used customary fillers, especially cements (for example Portland cements or alumina cements), chalks, sand, quartz sand, quartz powder or the like, which can be added in the form of powder, in granular form or in the form of shaped bodies, or other fillers, such as especially kernel flours or shell flours from plants, which further increases the biogenic carbon content, such as olive stone flour, coconut shell flour or furthermore walnut shell flour, or hydraulic fillers, as described above under the epoxides, or mixtures of two or more thereof, it being possible for the fillers furthermore or especially also to be silanised.

The fillers can be present in one or more components of a multi-component synthetic resin adhesive composition according to the invention, for example one or both components of a corresponding two-component kit; the content of fillers is preferably from 0 to 90% by weight, for example from 10 to 50% by weight (in the case of the installation of anchoring elements, broken casing material (for example splintered glass or splintered plastics), for example fragments of capsules, can also be counted as filler). In addition or as an alternative to one or more of the mentioned fillers, hydraulically hardenable fillers, such as gypsum, burnt lime or cement (for example alumina cement or Portland cement), water glasses or active aluminium hydroxides, or two or more thereof, can be added.

Further ingredients can also be added, such as plasticisers, non-reactive diluents, flexibilisers, stabilisers, rheology aids, wetting and dispersing agents, colouring additives, such as dyes or especially pigments, for example for staining the components different colours for better monitoring of their intermixing, or the like, or other additives, mixtures of two or more thereof. Such further additives can preferably be added in total in proportions by weight of in total from 0 to 90%, for example from 0 to 40% by weight.

As “further reactive diluents” (in addition to those according to the invention), for example for preferred vinyl esters or urethane(meth)acrylates, it is possible, in addition, for one or more (relatively low-viscosity) free-radical-hardening unsaturated reactive diluents in non-biogenic form also to be added, which are to be understood as being primarily those which comprise, as free-radical-curing (which includes “curable (for example prior to addition of hardener)”) components, organic compounds having unsaturated (for example, olefinic) radicals or, especially, which consist of such compounds, for example especially (meth)acrylate or (meth)acrylamide monomers, such as acrylic acid and/or methacrylic acid or preferably esters thereof (referred to as (meth)acrylates) or amides, especially (meth)acrylates such as mono-, di-, tri- or poly-(meth)acrylates (including hydroxyalkyl(meth)acrylates, such as hydroxypropyl(meth)acrylate or hydroxyethyl(meth)acrylate, alkyl(meth)acrylates having 1 to 10 (meth)acrylate groups, such as mono-, di-, tri-, tetra-, penta-, hexa- or poly-(meth)-acrylates, for example alkyl di- or tri-(meth)acrylates, such as 1,2-ethanediol di(meth)-acrylate (ethylene glycol di(meth)acrylate), butanediol di(meth)acrylate, such as 1,3- or especially 1,4-butanediol di(meth)acrylate, hexanediol di(meth)acrylate, 1,10-decanediol di(meth)acrylate, diethylglycol di(meth)acrylate, trimethylolpropane tri(meth)-acrylate, glycerol tri(meth)acrylate, polyglycerol poly(meth)acrylate, polyethylene glycol di(meth)acrylate, cycloalkyl(meth)acrylates, bicycloalkyl(meth)acrylates or heterocyclyl(meth)acrylates, wherein cycloalkyl or bicycloalkyl has from 5 to 7 ring carbon atoms and heterocyclyl has 5 or 6 ring atoms and 1 or 2 ring hetero atoms selected from N, O and S, such as tetrahydrofurfuryl(meth)acrylate or isobornyl(meth)acrylate, or acetacetoxyalkyl(meth)acrylate; or furthermore styrenes, such as styrene, α-methyl styrene, vinyl toluene, tert-butyl styrene and/or divinyl benzene; or mixtures of two or more thereof, as constituents that cure in parallel with the free-radical-hardening unsaturated reactive resin, for example in a proportion by weight of from 0.1 to 90% by weight, for example between 0.5 and 75% by weight or between 1 and 40% by weight.

As non-reactive diluents there can be added, for example, vegetable oils, such as castor oil, or furthermore bio-alcohols and fatty acids and esters thereof, or mixtures of two or more thereof, for example in a proportion of from 3 to 60% by weight, for example from 4 to 55% by weight.

The hardener includes at least one peroxide as actual initiator. The term “hardener” here preferably hereinabove and hereinbelow means pure initiators or stabilised initiators, with or without addition of filler, and/or further additives, such as water, thickeners and/or further additional substances, such as dyes, pigments, additives and the like, in other words the complete hardener component. For stabilisation, customary additives, such as gypsum, chalk, pyrogenic (preferably surface-treated, such as hydrophobised) silica, phthalates, chlorinated paraffin or the like, can be added. In addition, fillers and/or (especially for the preparation of a paste or emulsion) solvents (non-reactive diluents, such as, for example, liquid (for example, epoxidised or hydroxyl-group-containing) oils, for example castor oil, or water, thickeners, fillers (such as, for example, those mentioned above) and further additives of those mentioned above can also be added. The content of all additives can be, for example, a proportion by weight of in total from 0.1 to 99.5% by weight, for example from 1 to 99.5% by weight.

Based on the hardener component, the content of initiator (actual hardener) in a possible preferred embodiment of the invention is from 0.5 to 90% by weight, especially from 0.9 to 30% by weight.

As initiator for the hardening of the reactive resin formulations according to the invention there are used in the case of free-radical polymerisation, for example free-radical-forming peroxides, for example organic peroxides, such as diacyl peroxides, for example dibenzoyl peroxide, ketone peroxides, such as methyl ethyl ketone peroxide or cyclohexanone peroxide, or alkyl peresters, such as tert-butyl perbenzoate, inorganic peroxides, such as persulfates or perborates, and also mixtures thereof.

The proportion of hardener in a synthetic resin adhesive composition according to the invention, based on the mass (weight) of all reactants and additives without packaging, preferably lies in a range of from 1 to 60% by weight, for example from 2 to 50% by weight, it being possible for the proportion of peroxide, likewise based on the mass of the total associated reactive resin formulation (100%), to be 0.1 or more % by weight, in an especially preferred embodiment from 0.1 to <1% by weight, furthermore also from 1 to 10% by weight.

The free-radical-hardenable unsaturated reactive resin (and/or the totality of its components) is provided, for example, in a proportion by weight of from 5 to 99.5%, such as for instance from 10 to 98.5%, for example from 10 to 89.5%.

Here too, “based on” means that the synthetic resin adhesive compositions according to the invention can also include, in addition to the mentioned components, further customary ingredients (for example additives or other constituents as mentioned hereinabove or hereinbelow). Such further ingredients can be present together, for example in an amount of in total up to 80% by weight, preferably between 0.01 and 65% by weight. Even where “based on” is not expressly mentioned, such customary ingredients are included.

A hole or crevice is to be understood as being a hole or crevice that is present in a solid substrate (especially already completed as such), especially masonry or concrete, optionally also in a cracked substrate, such as cracked concrete, and is accessible from at least one side, for example a drilled hole, or furthermore a recessed region made during mortaring with inorganic mortar or plastering materials (such as cement or gypsum), or the like.

In a special embodiment of the subject-matter of the invention, the hardenable components and the associated hardeners (hardener components) are stored separately from one another in a two-component or multi-component system before they are mixed with one another at the desired site (for example close to or in a hole or crevice, such as a drilled hole).

The injectable synthetic resin systems according to the invention are provided as multi-component systems (for example, a multi-component kit) and are also used as such.

A multi-component kit is understood to be especially a two-component or (furthermore) multi-component kit (preferably a two-component kit) having a component (A), which comprises either one or more free-radical-hardenable (=hardening after addition of a free-radical-former (hardener)) reactive synthetic resins or one or more reactive synthetic resins based on epoxy, as described hereinabove and hereinbelow, and the respective associated hardener (component (B)), as defined hereinabove and hereinbelow, it being possible for further additives to be provided in one or both of the components, preferably a two-chamber or furthermore multi-chamber apparatus, wherein the components (A) and (B) that are able to react with one another and optionally further separate components are present in such a way that their constituents cannot react with one another (especially not curing) during storage, preferably in such a way that their constituents do not come into contact with one another prior to use, but that enables components (A) and (B) and optionally further components to be mixed together for fixing at the desired location, for example directly in front of or in a hole, and, if necessary, introduced in such a way that the hardening reaction can take place therein. Also suitable are capsules, for example made of plastics, ceramics or especially glass, in which the components are arranged separated from one another by means of rupturable boundary walls (which can be ruptured, for example, when an anchoring element is driven into a hole or crevice, such as a drilled hole) or integrated separate rupturable containers, for example in the form of capsules, such as ampoules, arranged one inside the other; and also especially multi-component or especially two-component cartridges (which are likewise especially preferred), the chambers of which contain the plurality of components or preferably the two components (especially (A) and (B)) of the synthetic resin adhesive composition according to the invention having the compositions mentioned hereinabove and hereinbelow for storage prior to use, the kit in question preferably also including a static mixer.

Advantageously, the packaging materials (such as films, cartridges (also static mixers) or plastics capsules) can likewise be made from plastics having a high or completely biogenic carbon content, for example from corresponding polyamides or the like.

The use of a synthetic resin adhesive composition according to the invention at the desired site of use is effected by mixing the associated components (separated before mixing so as to inhibit a reaction), especially close to and/or directly in front of a hole or (for example especially when cartridges having static mixers are used) directly in front of and/or (especially when suitable capsules or ampoules are broken) inside a hole or crevice, for example a drilled hole.

“Embedding in mortar” is especially to be understood as meaning (material-bonded and/or interlocking) fixing of anchoring means made of metal (for example undercut anchors, threaded rods, screws, drill anchors, bolts) or, furthermore, made of some other material, such as plastics or wood, in solid substrates (preferably already completed as such), such as concrete or masonry, especially insofar as they are components of artificially erected structures, more especially masonry, ceilings, walls, floors, panels, pillars or the like (for example made of concrete, natural stone, masonry made of solid blocks or perforated blocks, furthermore plastics or wood), especially in holes, such as drilled holes. Those anchoring means can then be used to secure, for example, railings, covering elements, such as panels, façade elements or other structural elements.

Where “mixtures of two or more thereof” are mentioned, this includes especially mixtures of at least one of the mentioned constituents, which are emphasised as being preferred, with one or more other components, especially one or more components likewise identified as being preferred.

“Completed as such” means especially that the substrates are, except for possible surface modifications (such as coating, for example plastering or painting) or the like, already completed (for example, as building modules or walls) and are not completed only at the same time as the adhesive composition or are not made from the latter. In other words: the adhesive composition itself is not, then, already-completed substrate.

The introduction of the anchoring means is preferably effected only a short time, preferably 30 minutes or less, after the components of the fixing mortar according to the invention have been mixed together. In explanation: the mixing/introduction of the components at/into the desired locations at which anchoring means are to be fixed initiates a plurality of reactions which proceed substantially in parallel and/or with only a very small time interval between them. The final curing takes place in situ.

Specific embodiments of the invention also relate to the variants mentioned in the claims and abstract—the claims and the abstract are therefore incorporated herein by reference.

The Examples that follow serve to illustrate the invention, without limiting its scope, but also show special embodiments of the invention (it also being possible for each individual specifically mentioned constituent to be used in any of the subject-matter of the invention mentioned hereinabove and hereinbelow instead of a general term, or a plurality or all thereof, which defines special embodiments of the invention).

### EXAMPLE 1

### Two-Component Adhesive Compositions According to the Invention Based on Free-Radical-Hardenable Reactive Resins

Components (A) suitable for use according to the invention were prepared from the following polymerisable components:

| | Mortar 1 | Mortar 2 | Mortar 3 | Mortar 4 | Mortar 5 | Mortar 6 |
|---|---|---|---|---|---|---|
| | Content % | Content % | Content % | Content % | Content % | Content % |
| Raw material | by weight | by weight | by weight | by weight | by weight | by weight |
| ethoxylated | 19 | 16 | 16 | 17 | 17 | 20 |
| bisphenol A | | | | | | |
| dimethacrylate (*) | | | | | | |
| tetrahydrofurfuryl | 9.9 | 9.9 | | | | |
| methacrylate | | | | | | |
| Sarbio 6100* | | | | | | |
| isobornyl | | | | | | 18 |
| methacrylate* | | | | | | |
| epoxidised | | 5 | | | | |
| soybean oil | | | | | | |
| acrylate CN111* | | | | | | |
| 1,10-decanediol | | | 9.9 | | | |
| dimethacrylate | | | | | | |
| Sarbio 5201* | | | | | | |
| polyglycerol | | | 5 | | | |
| acrylate* | | | | | | |
| sorbitol acrylate | | | | 5 | | |
| (BASF)* | | | | | | |
| glycerol | | | | 5 | | |
| trimethacrylate* | | | | | | |
| methacrylated | | | | | 9.9 | |
| fusel oil* | | | | | | |
| inhibitor mixture | 0.05 | 0.05 | 0.05 | 0.05 | 0.05 | 0.05 |
| (selected from | | | | | | |
| t-BBC, hydro- | | | | | | |
| quinone and/or | | | | | | |
| tempol) | | | | | | |
| aminic | 0.65 | 0.65 | 0.65 | 0.65 | 0.65 | 0.65 |
| accelerator | | | | | | |
| pyrogenic | 1.5 | 1.5 | 1.5 | 1.5 | 1.5 | 1.5 |
| surface-treated | | | | | | |
| silica | | | | | | |
| quartz powder | 41.9 | 41.9 | 41.9 | 43.8 | 43.9 | 39.8 |
| olive stone flour | 27 | 25 | 25 | | | |
| coconut shell | | | | 27 | 25 | 20 |
| flour | | | | | | |
| | 100 | 100 | 100 | 100 | 100 | 100 |
| Biocontent [%] | 50.5 | 56 | 54 | 54 | 52 | 52 |

*= reactive diluents or resins according to the invention that are biogenic or at least have a biogenic content
(*) reactive resins according to the invention that are potentially biogenic or at least have a biogenic content
“Sarbio” is a mark of Sartomer Europe, Colombes Cedex, France
Soybean oil acrylate CN111 is likewise by Sartomer Europe

In each case there is used as hardener component (B):

Hardener component 1

| Raw material | Amount used [%] |
|---|---|
| castor oil | 40.00 |
| dibenzoyl peroxide 33% | 16.00 |
| in inert filler | |
| quartz sand | 41.50 |
| pyrogenic surface- | 2.00 |
| treated silica | |
| pigment | 0.50 |
| | 100.00 |

The hardener has a density of 1.50 g/ccm and a viscosity of 120 Pa*s at 23° C., measured using a Brookfield no. 7 spindle at 10 rpm. The bio-carbon content is 88.9%.

Fixing mortars are prepared with all mortar/hardener combinations (ratio by volume of component (A) to (B)=5:1). Good to very good bond strengths in the range of 15-23 N/mm² were achieved with all fixing mortars.

### EXAMPLE 2

### Two-Component Adhesive Compositions According to the Invention Based on Epoxy-Based Reactive Resins

Components (A) suitable for use according to the invention were prepared from the following polymerisable components:

| | Mortar 7 | Mortar 8 | Mortar 9 | Mortar 10 |
|---|---|---|---|---|
| | Content | Content | Content | Content |
| | % by | % by | % by | % by |
| Raw material | weight | weight | weight | weight |
| bisphenol A/F resin with | 45 | 45 | 45 | 45 |
| a bio-C content of 28% | | | | |
| (Spolchemie) | | | | |
| trimethylolpropane | 15 | | | 5 |
| triglycidyl ether, bio-C | | | | |
| content 64% | | | | |
| glycerol triglycidyl ether, | | 20 | 20 | 15 |
| bio-C content 100% | | | | |
| wetting and dispersing | 2 | 2.5 | 2.5 | 2 |
| agent | | | | |
| pyrogenic surface-treated | 2 | 2 | 2 | 3 |
| silica | | | | |
| quartz sand | 7.5 | | | |
| lignin sulfonate | | | 10.5 | |
| olive stone flour | 28 | | 20 | |
| coconut shell flour | | | | 30 |
| walnut shell flour | | 30 | | |
| pigment | 0.5 | 0.5 | | |
| | 100 | 100 | 100 | 100 |
| Biocontent [%] | 50 | 58 | 56 | 57 |

In each case there is used as hardener component (B):

Hardener component 1

| Raw material | Amount used [%] |
|---|---|
| Mannich base formulation | 60.00 |
| based on cardanol | |
| vegetable charcoal | 37.50 |
| pyrogenic surface-treated | 2.50 |
| silica | |
| | 100.00 |

The hardener has a density of 1.28 g/ccm and a viscosity of 160 Pa*s at 23° C., measured using a Brookfield no. 7 spindle at 10 rpm. The bio-carbon content is 73%.

Fixing mortars are prepared with all mortar/hardener combinations (ratio by volume of component (A) to (B)=3:1). Very good bond strengths in the range of 18-25 N/mm² were achieved with the fixing mortars.

1. A multi-component synthetic resin adhesive composition for the fixing, comprising reactive diluents and/or resins, wherein the reactive diluent and/or the reactive resin comprise(s) at least one reactive diluent and/or reactive resin that is biogenic or has a biogenic content.

2. The multi-component synthetic resin adhesive composition according to claim 1, wherein the reactive diluent or the reactive resin having biogenic content from those having one or more reactive groups which are obtainable by reaction of, on the one hand, one or more starting materials selected from non-biogenic or biogenic epichlorohydrin and non-biogenic or biogenic (meth)acrylic acid with OH— or SH— or amino (NH₂—) or imino (—NH—) groups contained in likewise biogenic complementary starting materials, or two or more of those groups, wherein at least one of the mentioned starting materials is at least partly biogenic.

3. The multi-component synthetic resin adhesive composition according to claim 1, wherein the reactive diluents and/or reactive synthetic resins having biogenic content are (meth)acrylates, having a biogenic (meth)acrylate portion, of hydroxy-group-containing vegetable oils, entirely or at least partly biogenic alkane(mono-, di-, tri-, tetra-, penta-, hexa- or poly-)ol (meth)acrylates, entirely or partly biogenic (meth)acrylates of sugar alcohols, entirely or partly biogenic (meth)acrylated fusel oils, entirely or partly biogenic 5- or 6-membered ring heterocyclyl(meth)acrylates, partly or preferably entirely biogenic glycerol- or polyglycerol-(meth)acrylates, entirely or partly biogenic saccharide methacrylates, or UP resins with biogenic or non-biogenic polycarboxyl compounds and biogenic or non-biogenic di- or poly-ols, wherein at least one of the carboxyl and di- or poly-ol radicals is biogenic.

4. The multi-component synthetic resin adhesive composition according to claim 1, characterised in that the reactive diluents having biogenic content are epoxidised soybean oil (meth)acrylate, 1,10-decanediol di(meth)acrylate, tetrahydrofuryl methacrylate, isobornyl methacrylate, sorbitol(meth)acrylate, (meth)acrylated fusel oil, or purely biogenic glycerol tri(meth)acrylate or one in which at least the (meth)acrylate portion is biogenic, or mixtures of two or more such at least partly biogenic reactive diluents.

5. The multi-component synthetic resin adhesive composition according to claim 1, wherein the reactive diluents having biogenic content are those selected from entirely or partly, in the glycidyl portion, biogenic alkane(mono-, di-, tri-, tetra-, penta-, hexa- or poly-)ol (mono-, di-, tri-, tetra-, penta-, hexa- or poly-)glycidyl ethers.

6. The multi-component synthetic resin adhesive composition according to claim 1, wherein the proportion of reactive diluent having biogenic content is from 0.5% to 80% by weight, based on all components of the adhesive composition apart from the packaging.

7. The multi-component synthetic resin adhesive composition according to claim 1, wherein the proportion of biogenic carbon, determinable in accordance with the certification program for bio-based products according to ASTM 6866 by TÜV Rheinland, based on the total formulation without packaging, is at least 20, >50, at least 55, at least 60, at least 65, at least 75, at least 80 or >85% by weight.

8. The multi-component synthetic resin adhesive composition according to claim 1, wherein the synthetic resin adhesive composition is a two-component kit, having a reactive synthetic resin component (A) and a hardener component (B).

9. The multi-component synthetic resin adhesive composition according to claim 8, comprising the content of reactive diluent having biogenic content in the synthetic resin component (A).

10. The multi-component synthetic resin adhesive composition according to claim 8, comprising a hardener having biogenic content in the hardener component (B).

11. The multi-component synthetic resin adhesive composition according to claim 1, comprising, as a reactive synthetic resin component (A), a reactive synthetic resin based on epoxy or a free-radical-hardenable reactive synthetic resin, and also comprising a hardener component (B).

12. The multi-component synthetic resin adhesive composition according to claim 11, comprising, as reactive synthetic resin component (A), a free-radical-hardenable reactive synthetic resin and, as hardener component (B), such a component having a peroxide as initiator.

13. The multi-component synthetic resin adhesive composition according to claim 11, characterised in that it comprises, in the or a reactive synthetic resin component (A), epoxy(meth)acrylates of formula 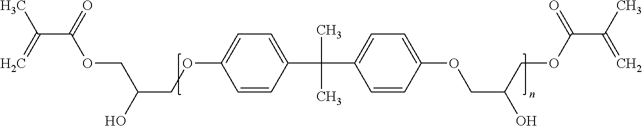
wherein n denotes a number greater than or equal to 1, and/or propoxylated or ethoxylated aromatic diol-(meth)acrylates of formula 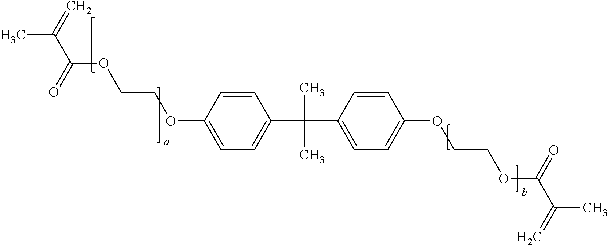
wherein a and b each independently of the other denote a number greater than or equal to 0, with the proviso that preferably at least one of the values is greater than 0, preferably both values being 1 or more, and/or one or more urethane(meth)acrylates.

14. The multi-component synthetic resin adhesive composition according to claim 1, wherein the hardenable (=hardening in the presence of hardener) reactive resin(s) based on epoxy in the reactive synthetic resin component (A) comprise(s), as epoxy, polyglycidyl ethers of novolak, bisphenol F or bisphenol A, or mixtures of such epoxides, preferably entirely or partly of biogenic nature, and, in the hardener component (B), as hardener, those having two or more groups selected from amino, imino and mercapto, for example corresponding amines or thiols, or furthermore thioalcohols, aminoalcohols or aminothiols, entirely or partly bio-based Mannich base formulations, or mixtures of such compounds.

15. The multi-component synthetic resin adhesive composition according to claim 1, comprising one or more further ingredients, selected from aminic accelerators, inhibitors (in the case of free-radical reactive resins), reactive diluents, thixotropic agents, further fillers and furthermore further ingredients.

16. The multi-component synthetic resin adhesive composition according to claim 1, wherein the synthetic resin adhesive composition is a two-component system, in the form of a two-chamber cartridge with or without a static mixer.

17. A two-component or multi-component synthetic resin adhesive composition, comprising:
a.) a hardenable reactive resin;
b.) a hardenable reactive diluent having a viscosity <800 mPa*s, measurable using a Brookfield viscometer at 23° C. with a no. 3 spindle at 20 rpm;
c.) a hardener, by means of which a.) and b.) are hardened and/or by means of which the hardening thereof is initiated; and
wherein the content of biogenic carbon is >20%.

18. A method of using a multi-component synthetic resin adhesive composition according to claim 1, comprising introducing the synthetic resin adhesive composition and an anchoring means into a hole or crevice, and causing the synthetic resin adhesive composition to cure.

19. (canceled)

20. A method of producing the multi-component synthetic resin adhesive composition according to claim 1, comprising introducing at least one reactive diluent comprising a reactive diluent having biogenic content.
